(19) United States
(12) Patent Application Publication
(10) Pub. No.: US 2019/0215606 A1
(43) Pub. Date: Jul. 11, 2019

(54) VEHICLE AND METHOD FOR CONTROLLING THE SAME

(71) Applicants: Hyundai Motor Company, Seoul (KR); Kia Motors Corporation, Seoul (KR); Korea Advanced Institute of Science and Technology, Daejeon (KR)

(72) Inventors: Jung Keun You, Suwon (KR); Jinseok Hong, Seongnam (KR); Kaangdok Yee, Yongin (KR); Jung Woo Choi, Daejeon (KR); Hyungjun So, Seoul (KR)

(21) Appl. No.: 16/178,235

(22) Filed: Nov. 1, 2018

(30) Foreign Application Priority Data
Jan. 5, 2018 (KR) 10-2018-0001992

(51) Int. Cl. H04R 3/12; H04R 1/02; H04R 1/28

(52) U.S. Cl. CPC H04R 3/12; H04R 2499/13; H04R 1/2834; H04R 1/025

(57) ABSTRACT

A vehicle may include: a plurality of speakers disposed in the vehicle; a plurality of headrest speakers, each of which disposed in a headrest of a seat in the vehicle; and a controller configured to divide an internal space of the vehicle into a plurality of areas according to a predetermined reference, to determine an area of the plurality of areas to be used as a destination of sound from a speaker of the plurality of speakers, to generate a control signal by which the sound from the speaker is output to the determined area and not output to any area of the plurality of areas other than the determined area, and to control a headrest speaker of the plurality of headrest speakers disposed in a headrest of a seat in the determined area so as to output the sound.

### CROSS-REFERENCE TO RELATED APPLICATION

This application is based on and claims the benefit of priority under 35 U.S.C. § 119 to Korean Patent Application No. 10-2018-0001992, filed on Jan. 5, 2018 in the Korean Intellectual Property Office, the disclosure of which is incorporated by reference in its entirety as if fully set forth herein.

### BACKGROUND

### 1. Technical Field

Embodiments of the present disclosure relate to a vehicle and a method for controlling the same, and more particularly, to a vehicle having an internal space so that the sound from a speaker and a headrest speaker is output only to a predetermined specific area and not output to other areas, and a method for controlling the same.

### 2. Description of the Related Art

Recently, the demand of drivers and passengers for interworking technology between a vehicle and an external terminal, such as a smartphone, has increased. For example, a driver or passenger of a vehicle may desire to listen to music of their choice through interworking with an audio-video-navigation (AVN) device of the vehicle.

Problematically, the driver and the passenger may desire to listen to different music. In addition, if a call is made through a Bluetooth connection in the vehicle, a person other than the person who is making the call may overhear the contents of the conversation. Further, various sounds such as warning sounds, navigation guidance sounds, and the like, may be output inside of the vehicle, causing unnecessary disruption for the driver or passenger.

Therefore, there is a need for dividing the internal area of the vehicle into sound output areas or sound arrival areas so that only the passenger(s) located within a predetermined area may listen to sounds (e.g., music, calls, etc.) output inside the vehicle. Further, there is a need for effectively outputting sound to a divided sound output area in the vehicle.

### SUMMARY

It is an aspect of the present disclosure to provide a vehicle and a method for controlling the same, in which the sound from a speaker provided in the vehicle and a headrest speaker provided in a seat is controlled to be output only to a predetermined specific internal area of the vehicle, and not output to other areas of the vehicle, so that only the person(s) (e.g., driver and/or passengers) desiring to listen to the sound can hear the sound.

Additional aspects of the present disclosure will be set forth in part in the description which follows and, in part, will be apparent from the description, or may be learned by practice of the present disclosure.

In accordance with embodiments of the present disclosure, a vehicle may include: a plurality of speakers disposed in the vehicle; a plurality of headrest speakers, each of which disposed in a headrest of a seat in the vehicle; and a controller configured to divide an internal space of the vehicle into a plurality of areas according to a predetermined reference, to determine an area of the plurality of areas to be used as a destination of sound from a speaker of the plurality of speakers, to generate a control signal by which the sound from the speaker is output to the determined area and not output to any area of the plurality of areas other than the determined area, and to control a headrest speaker of the plurality of headrest speakers disposed in a headrest of a seat in the determined area so as to output the sound.

The vehicle may further include: a sound signal processor configured to receive a sound signal corresponding to the sound from an external source.

The sound signal processor may determine a type of the sound signal, the type of the sound signal corresponding to one of a music playback signal, a video playback signal, a voice call signal, a navigation guidance signal, and a warning signal.

The controller may determine the headrest speaker to be used as a destination of the sound among the plurality of headrest speakers based on the determined type of the sound signal.

Each of the plurality of headrest speakers may include a passive radiator configured to amplify the sound signal when the sound signal has a frequency less than or equal to a predetermined value.

The controller may control the passive radiator so as to amplify the frequency of the sound signal.

Each of the plurality of headrest speakers may be installed at a predetermined angle in a particular headrest.

The controller may determine the area to be used as the destination of the sound based on the determined type of the sound signal.

The controller may generate the control signal such that the sound output to the determined area causes constructive interference and another sound output to any area of the plurality of areas other than the determined area causes destructive interference.

The speaker may output the sound to the determined area due to the constructive interference caused by the control signal, and not output the sound to any area of the plurality of areas other than the determined area due to the destructive interference caused by the control signal.

The controller may determine the determined area to be used as the destination of the sound based on a distance between one of the areas of the plurality of areas and the speaker.

The controller may generate the control signal such that the constructive interference and the destructive interference caused by the sound is based on a distance between one of the areas of the plurality of areas and the speaker.

The controller may determine the speaker for outputting the sound among the plurality of speakers, and generate the control signal such that the constructive interference and the destructive interference is caused by the sound output from the determined speaker.

Furthermore, in accordance with embodiments of the present disclosure, a method for controlling a vehicle may include: providing a plurality of speakers in the vehicle; providing a plurality of headrest speakers, each of which disposed in a headrest of a seat in the vehicle; dividing an internal space of the vehicle into a plurality of areas according to a predetermined reference; determining an area of the plurality of areas to be used as a destination of sound from a speaker of the plurality of speakers; generating a control signal by which the sound from the speaker is output to the determined area; generating the control signal by which the sound is not output to any area of the plurality of areas other than the determined area; and controlling a headrest speaker of the plurality of headrest speakers disposed in a headrest of a seat in the determined area so as to output the sound.

The method may further include: receiving a sound signal corresponding to the sound from an external source.

The method may further include: determining a type of the sound signal, the type of the sound signal corresponding to one of a music playback signal, a video playback signal, a voice call signal, a navigation guidance signal, and a warning signal.

The method may further include: determining the headrest speaker to be used as a destination of the sound among the plurality of headrest speakers based on the determined type of the sound signal.

The controlling of the headrest speaker so as to output the sound may further include amplifying the sound signal when the sound signal has a frequency less than or equal to a predetermined value.

The controlling of the headrest speaker so as to output the sound may further include amplifying the frequency of the sound signal.

The determining of the area of the plurality of areas may include determining the area to be used as the destination of the sound based on the determined type of the sound signal.

The generating of the control signal may include generating the control signal such that the sound output to the determined area causes constructive interference and another sound output to any area of the plurality of areas other than the determined area causes destructive interference.

The method may further include outputting the sound to the determined area due to the constructive interference caused by the control signal; and not outputting the sound to any area of the plurality of areas other than the determined area due to destructive interference caused by the control signal.

The determining of the area of the plurality of areas may include determining the area to be used as the destination of the sound based on a distance between one of the areas of the plurality of areas and the speaker.

The generating of the control signal may further include generating the control signal such that the constructive interference and the destructive interference caused by the sound is based on a distance between one of the areas of the plurality of areas and the speaker.

The method may further include: determining the speaker for outputting the sound among the plurality of speakers; and generating the control signal such that the constructive interference and the destructive interference is caused by the sound output from the determined speaker.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a perspective view schematically illustrating an exterior of a vehicle according to embodiments of the present disclosure;

FIG. 2 is a view illustrating an interior of the vehicle according to embodiments of the present disclosure;

FIG. 3 is a view illustrating a speaker and a headrest speaker mounted in the vehicle according to embodiments of the present disclosure;

FIG. 4 is a view illustrating the headrest speaker provided in a seat of the vehicle according to embodiments of the present disclosure;

FIG. 5 is a perspective view illustrating a configuration of the headrest speaker according to embodiments of the present disclosure;

FIG. 6 is a block diagram illustrating the vehicle according to embodiments of the present disclosure;

FIG. 7 is a conceptual diagram illustrating an internal space of the vehicle divided into one or more areas according to embodiments of the present disclosure;

FIG. 8 is a side conceptual diagram determining an area where a sound of the speaker is output to the divided areas according to embodiments of the present disclosure;

FIG. 9 is a conceptual diagram illustrating the sound of the speaker is output only to a determined area with respect to the divided areas according to embodiments of the present disclosure;

FIG. 10 is a conceptual diagram determining the speaker outputting the sound to the determined area according to embodiments of the present disclosure;

FIG. 11 is a side conceptual diagram determining an area where the sound of the speaker is output to the divided areas according to additional embodiments of the present disclosure;

FIG. 12 is a conceptual diagram illustrating the sound of the speaker is output only to a determined area with respect to the divided areas according to additional embodiments of the present disclosure;

FIG. 13 is a conceptual diagram determining the speaker outputting the sound to the determined area according to additional embodiments of the present disclosure; and

FIG. 14 is a flowchart illustrating a method for controlling a vehicle according to embodiments of the present disclosure.

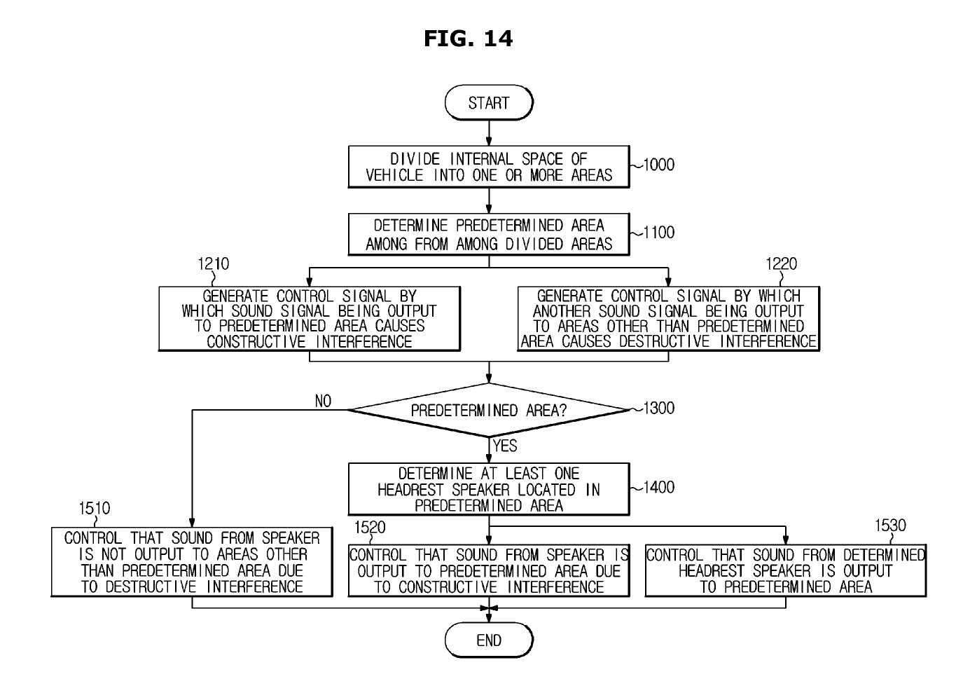

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Hereinafter, embodiments of the present disclosure will be described in detail with reference to the accompanying drawings. As those skilled in the art would realize, the described embodiments may be modified in various different ways, all without departing from the spirit or scope of the present disclosure.

Like reference numerals refer to like elements throughout the specification. Not all elements of embodiments of the present disclosure will be described, and description of what are commonly known in the art or what overlap each other in the embodiments will be omitted. The terms as used throughout the specification, such as “˜part,” “˜module,” “˜member,” “˜block,” etc., may be implemented in software and/or hardware, and a plurality of “˜parts,” “˜modules,” “˜members,” or “˜blocks” may be implemented in a single element, or a single “˜part,” “˜module,” “˜member,” or “˜block” may include a plurality of elements.

It will be further understood that the term “connect” or its derivatives refer both to direct and indirect connection, and the indirect connection includes a connection over a wireless communication network.

The term “include (or including)” or “comprise (or comprising)” is inclusive or open-ended and does not exclude additional, unrecited elements or method steps, unless otherwise mentioned.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section.

It is to be understood that the singular forms “a,” “an,” and “the” include plural references unless the context clearly dictates otherwise.

Reference numerals used for method steps are merely used for convenience of explanation, but not to limit an order of the steps. Thus, unless the context clearly dictates otherwise, the written order may be practiced otherwise.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one controller. The term “controller” may refer to a hardware device that includes a memory and a processor. The memory is configured to store program instructions, and the processor is specifically programmed to execute the program instructions to perform one or more processes which are described further below. The controller may control operation of units, modules, parts, or the like, as described herein. Moreover, it is understood that the below methods may be executed by an apparatus comprising the controller in conjunction with one or more other components, as would be appreciated by a person of ordinary skill in the art.

Hereinafter, embodiments of the present disclosure will be described with reference to accompanying drawings.

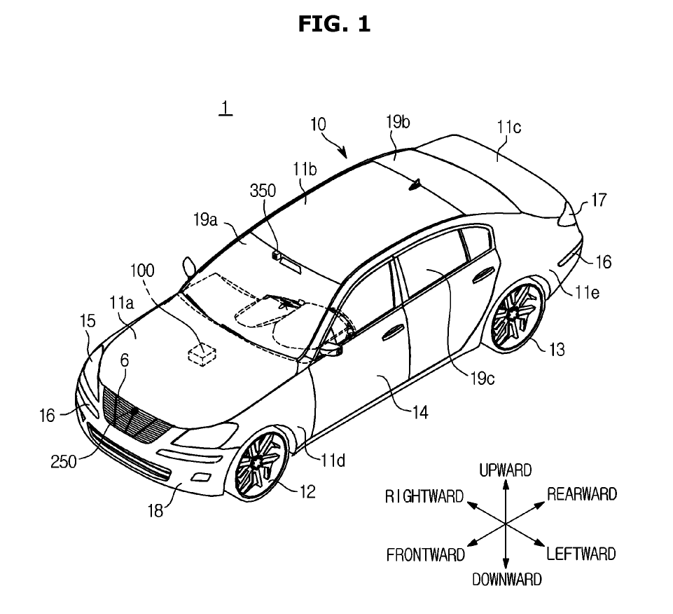

FIG. 1 is a perspective view schematically illustrating an exterior of a vehicle according to embodiments of the present disclosure.

For convenience of explanation, as shown in FIG. 1, a direction in which a vehicle 1 travels will be referred to as a forward direction, and left and right directions are distinguished based on the forward direction. When the forward direction corresponds to a twelve o'clock position, the right direction is defined to correspond to the three o'clock position or around the three o'clock position, and the left direction is defined to correspond to the nine o'clock position or around the nine o'clock position. The opposite direction of the forward direction is a rear direction. Additionally, a direction down to the floor of the vehicle 1 will be referred to as a downward direction, and a direction opposite to the downward direction will be referred to as an upward direction. Furthermore, a side located ahead will be referred to as a front side, a side located behind will be referred to as a rear side, and sides located on either sides will be referred to as sides. The sides include left and right sides.

As shown in FIG. 1, the vehicle 1 may include a vehicle body 10 that forms the exterior, and wheels 12, 13 for moving the vehicle 1.

The vehicle body 10 may include a hood 11 a for protecting various devices required for driving the vehicle 1, a roof panel 11b that forms an internal space, a trunk lid 11c of a trunk, front fenders 11d disposed on the sides of the vehicle 1, and quarter panels 11e. There may be a plurality of doors 14 disposed on the sides of the vehicle body 10 and hinged to the vehicle body 10.

A front window 19a is disposed between the hood 11a and the roof panel 11b for providing a view ahead of the vehicle 1, and a rear window 19b is disposed between the roof panel 11b and the trunk lid 11c for providing a view behind the vehicle 1. Side windows 19c may also be disposed at the upper part of the doors 14 to provide side views.

Headlamps 15 may be disposed at the front of the vehicle 1 for illuminating a direction in which the vehicle 1 travels.

Turn signal lamps 16 may also be disposed on the front and back of the vehicle 1 for indicating a direction in which the vehicle 1 will turn.

The vehicle 1 may blink the turn signal lamp 16 to indicate a turning direction. Tail lamps 17 may also be disposed at the back of the vehicle 1. The tail lamps 17 may indicate a state of gear shift, a state of brake operation of the vehicle 1, etc.

The vehicle 1 may include a detection sensor 250. The detection sensor 250 may obtain information regarding a position of an obstacle such as a pedestrian around the vehicle 1 and specifically obtain information regarding coordinates of the obstacle based on the vehicle 1.

The detection sensor 250 may be installed in the radiator grill 6 of the vehicle 1, and there is no limitation on the number and installation location of the detection sensor 250. In addition, the detection sensor 250 may be implemented using various devices such as, for example, a radar using millimeter waves or microwaves, a light detection and ranging (LiDAR) using pulsed laser beams, a vision using visible light, an infrared sensor using infrared rays, an ultrasonic sensor using ultrasonic waves, and the like. The detection sensor 250 may be implemented using any one of these, or may be implemented by a combination of these.

When the detection sensor 250 is implemented as the radar, the detection sensor 250 may irradiate millimeter waves or microwaves in front of the vehicle 1 and receive millimeter waves or microwaves reflected from the obstacle around the vehicle 1. After receiving the millimeter waves or microwaves, the detection sensor 250 may detect the physical properties such as a distance, a speed, and shape of the front obstacle from the reception time and intensity of waves, the change of frequency, and the like.

At least one controller 100 may be provided in the vehicle 1. The controller 100 may perform a function of performing electronic control related to the operation of the vehicle 1. The controller 100 may be installed at an arbitrary position in the vehicle 1 according to the designer's selection. For example, the controller 100 may be installed between an engine room and a dashboard, or may be provided in a center fascia. The controller 100 may include at least one processor that receives an electrical signal, processes the inputted electrical signal, and outputs the processed electrical signal. The processor may be implemented with at least one semiconductor chip and associated components. The semiconductor chip and associated components are mounted on a printed circuit board that can be installed in the vehicle 1.

At least one capturer 350 (e.g., imaging device, camera, video camera, etc.) may be provided in the vehicle 1. The capturer 350 may be configured to capture an image around the vehicle 1 while the vehicle 1 is being driven or stopped, and further obtain information regarding a position of the pedestrian.

It is understood that the exterior of vehicle 1 as described above and illustrated in FIG. 1 is provided merely for demonstration purposes and thus does not limit the scope of the present disclosure.

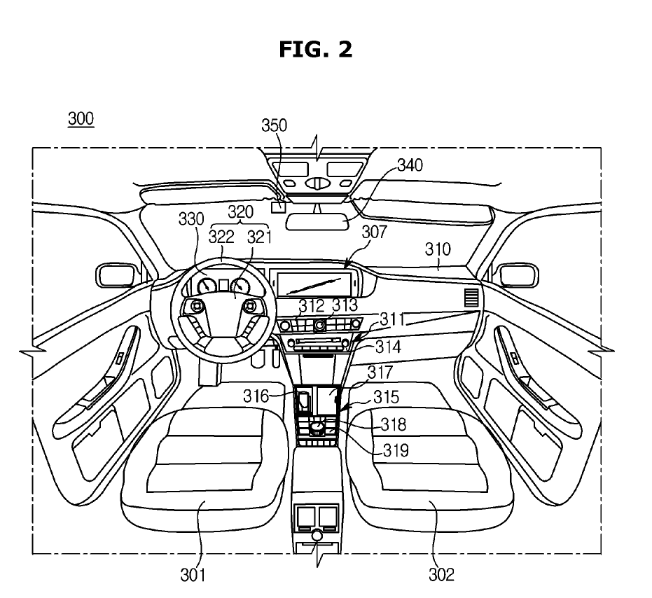

FIG. 2 is a view illustrating an interior of the vehicle according to embodiments of the present disclosure.

As shown in FIG. 2, an interior of the vehicle 1 includes a driver's seat 301, a passenger seat 302 adjacent to the driver's seat 301, a dashboard 310, a steering wheel 320, and an instrument panel 330.

The dashboard 310 refers to a panel that separates the internal room from the engine room and that has various parts required for driving installed thereon. The dashboard 310 is disposed in front of the driver's seat 301 and the passenger seat 302. The dashboard 310 may include a top panel, a center fascia 311, a gear box 315, and the like.

On the top panel of the dashboard 310, a vehicle display 307 may be installed. The vehicle display 307 may be configured to output various information in the form of images to a driver or passenger of the vehicle 1. For example, the vehicle display 307 may be configured to output various information, such as maps, weather, news, various moving or still images, information regarding the status or operation of the vehicle 1, e.g., information regarding the air conditioner, etc. Furthermore, the vehicle display 307 may provide the driver or passenger with an alert that corresponds to a level of danger to the vehicle 1. Specifically, when the vehicle 1 is about to change lanes, different alerts may be output to the driver according to different levels of danger. The vehicle display 307 may be implemented with a commonly-used navigation system.

Further, the vehicle display 307 may be installed inside a housing integrally formed with the dashboard 310 such that the display 307 may be exposed. Alternatively, the vehicle display 307 may be installed in the middle or the lower part of the center fascia 311, or may be installed on the inside of a windshield (not shown) or on the top of the dashboard 310 by a separate supporter (not shown). The vehicle display 307 may be installed at any position that may be considered by the designer.

Behind the dashboard 310, various types of devices, such as a processor, a communication module, a global positioning system (GPS) module, a storage, etc., may be installed. The processor installed in the vehicle 1 may be configured to operate various electronic devices installed in the vehicle 1, and may operate as the controller 100. The aforementioned devices may be implemented using various parts, such as semiconductor chips, switches, integrated circuits, resistors, volatile or nonvolatile memories, PCBs, and/or the like.

The center fascia 311 may be installed in the middle of the dashboard 310, and may include inputters 312 to 314 configured to receive various instructions related to the vehicle 1 from user input or selection. The inputters 312 to 314 may be implemented with mechanical buttons, knobs, a touch pad, a touch screen, a stick-type manipulation device, a trackball, or the like. The driver may execute many different operations of the vehicle 1 by manipulating various inputters 312, 314, 318 and 319.

The gear box 315 is disposed below the center fascia 311 between the driver's seat 301 and the passenger seat 302. In the gear box 315, a transmission 316, a container box 317, the various inputters 318 and 319, etc., are included. The inputters 318 and 319 may be implemented with mechanical buttons, knobs, a touch pad, a touch screen, a stick-type manipulation device, a trackball, or the like. The container box 317 and the inputters 318 and 319 may be omitted in some exemplary embodiments.

The steering wheel 320 and the instrument panel 330 are disposed on the dashboard 310 in front of the driver's seat 301.

The steering wheel 320 may be rotated in a particular direction by the manipulation of the driver, and accordingly, the front or back wheels of the vehicle 1 are rotated, thereby steering the vehicle 1. The steering wheel 320 may include a spoke 321 connected to a rotation shaft and a wheel for gripping 322 combined with the spoke 321. On the spoke 321, an inputter may be provided configured to receive various instructions as input from a user, and the inputter may be implemented with mechanical buttons, knobs, a touch pad, a touch screen, a stick-type manipulation device, a trackball, or the like.

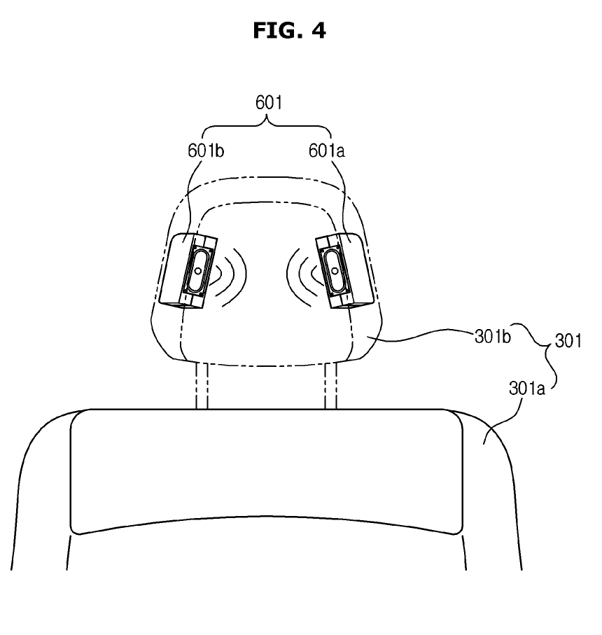

The wheel for gripping 322 may have a radial form to be conveniently manipulated by the driver, but is not limited thereto. Inside of at least one of the spoke 321 and the wheel for gripping 322, a vibrator 201 (in FIG. 4) may be installed for allowing at least one of the spoke 321 and the wheel for gripping 322 to vibrate at a particular intensity according to an external control signal. In some exemplary embodiments, the vibrator 201 may be configured to vibrate at various intensities based on external control signals, and accordingly, at least one of the spoke 321 and the wheel for gripping 322 may vibrate at various intensities. The vibrator 201 may be used in the vehicle 1 to provide haptic alerts or feedback to the driver.

For example, at least one of the spoke 321 and the wheel for gripping 322 may vibrate to an extent that corresponds to a level of danger determined when the vehicle 1 changes lanes. In particular, various alerts may be provided to the driver. Specifically, as the level of danger increases, the vibration of at least one of the spoke 321 and the wheel for gripping 322 increases to provide a high level of alert to the driver.

Further, the instrument panel 330 may provide the driver with various information related to the vehicle 1 such as the speed of the vehicle 1, engine revolutions per minute (rpm), fuel remaining, temperature of engine oil, flickering of turn signals, distance traveled by the vehicle, etc. The instrument panel 330 may be implemented with lights, indicators, or the like, and it may be implemented with a display panel as well, in some exemplary embodiments. When the instrument panel 330 is implemented with the display panel, in addition to the aforementioned information, the instrument panel 330 may provide other various information such as the gas mileage, whether various functions of the vehicle 1 are performed, or the like to the driver via the display. The instrument panel 330 may be configured to output and provide different alerts for the user based on different levels of danger to the vehicle 1. Specifically, when the vehicle 1 is about to change lanes, the instrument panel 330 may provide different alerts to the driver based on differently determined levels of danger (e.g., danger levels being associated with, for example, probability or likelihood of collision with another vehicle during the lane change).

A mirror 340 may be provided at the internal top of the vehicle 1 and the driver may view the internal room of the vehicle 1 or the rear of the vehicle 1 through the mirror 340.

As described above, the capturer 350 may be provided in the vehicle 1. While the capturer 350 may be disposed around the mirror 340 of the vehicle (e.g., rearview mirror) in FIG. 2, the location of the capturer 350 is not limited thereto, and may be disposed at any place in the vehicle that allows the capturer 350 to obtain image information by capturing an image of the inside or outside of the vehicle 1. The capturer 350 may be configured to capture an image around the vehicle 1 while the vehicle 1 is being driven or stopped, and may detect a pedestrian around the vehicle 1 and obtain information regarding the position of the pedestrian.

The capturer 350 may include at least one imaging device or camera, and further include a three dimensional (3D) space recognition sensor, radar sensor, ultrasound sensor, etc., to capture a more accurate image. For the 3D space recognition sensor, a KINECT (RGB-D sensor), TOF (Structured Light Sensor), stereo camera, or the like may be used, without being limited thereto, and any other devices having a similar function may also be used.

It is understood that the interior of vehicle 1 as described above and illustrated in FIG. 2 is provided merely for demonstration purposes and thus does not limit the scope of the present disclosure.

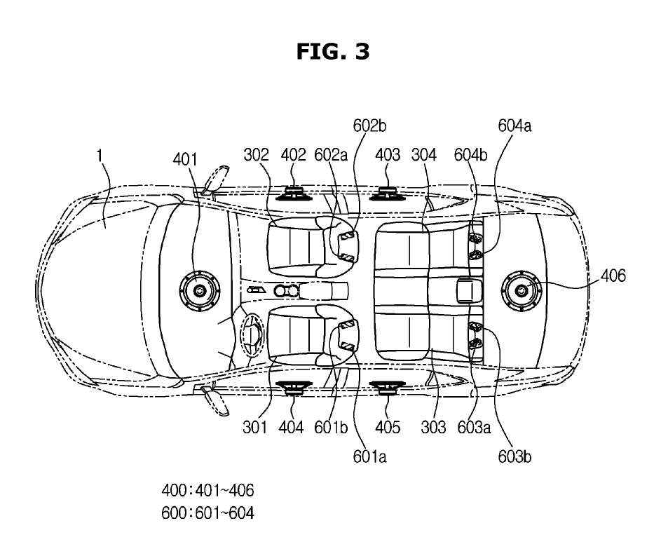

FIG. 3 is a view illustrating a speaker and a headrest speaker mounted in the vehicle according to embodiments of the present disclosure. As shown in FIG. 3, a plurality of speakers 400 may be provided in the vehicle 1 to output sound.

The speakers 400 may be installed at any position in the vehicle 1, and the number and position of the speakers 400 are not limited.

The speakers 400 may be provided in the vehicle 1 so as to generate constructive interference or destructive interference with a sound signal of a low frequency band and the sound signal of a middle-high frequency band to output sound. That is, since the effect of outputting sound only to a predetermined area inside the vehicle 1 may vary depending on the number and arrangement of the speakers 400, the number and arrangement of the speakers 400 may vary.

As shown in FIG. 3, six speakers 401 to 406 may be provided in the vehicle 1 as an example. That is, the speakers 400 may include a speaker 1 401 provided on the front surface of the vehicle 1, a speaker 6 406 provided on the rear surface of the vehicle 1, a speaker 4 404 provided on the driver's seat 301 side of the vehicle 1, a speaker 5 405 provided on a rear seat 303 of the driver's seat 301 of the vehicle 1, a speaker 2 402 provided on the passenger seat 302 of the vehicle 1, and a speaker 3 403 provided on a rear seat 304 of the passenger seat 302 of the vehicle 1.

Referring to FIGS. 3 and 4, headrest speakers 600 may be provided in a seat provided in the vehicle 1 according to embodiments of the present disclosure. Specifically, FIG. 4 is a view illustrating the headrest speaker provided in a seat of the vehicle according to embodiments of the present disclosure. As shown in FIG. 4, the driver's seat 301 may include a backrest 301a for supporting the driver's body and a headrest 301b corresponding to the driver's head.

The headrest speakers 600 may be provided in the headrest of the seat, and may output the sound to the driver or the passenger on the seat. The headrest speakers 600 may be installed to the headrest provided in each seat of the vehicle 1, but the number and position of the headrest speakers 600 are not limited thereto.

Specifically, as shown in FIG. 3, a headrest speaker 1 601 may be provided in the driver's seat 301. The headrest speaker 1 601 may include a left headrest speaker 1 601a and a right headrest speaker 1 601b. A headrest speaker 2 602 may be provided in the passenger seat 302. The headrest speaker 2 602 may include a left headrest speaker 2 602a and a right headrest speaker 2 602b.

Also, a headrest speaker 3 603 may be provided in the rear seat 303 of the driver's seat 301. The headrest speaker 3 603 may include a left headrest speaker 3 603a and a right headrest speaker 3 603b. A headrest speaker 4 604 may be provided in the rear seat 304 of the passenger seat 302. The headrest speaker 4 604 may include a left headrest speaker 4 604a and a right headrest speaker 4.

The headrest speakers 600 may be installed at a predetermined angle in the headrest provided in the seat inside the vehicle 1. That is, as shown in FIG. 4, the headrest may be embedded at a predetermined angle, and the passenger can listen to the sound from the headrest speaker effectively because the headrest is tilted toward the ear of the passenger seated on the seat.

The headrest speakers 600 may be used for enhancing a sound field separation effect for each seat in performing sound separation in the area where the sound is output and in the area where the sound is not output with respect to the area inside the vehicle 1.

When the sound from the speakers 400 provided in the vehicle 1 is output only to the determined area inside the vehicle 1 and is controlled so as not to be output to areas other than the determined area, the larger the sound contrast in areas other than the determined area, the better the effect of the sound separation in each area.

For example, in a case where only the driver seated on the driver's seat 301 listens to the sound from the speakers 400 and the passenger seated on the passenger seat 302 is controlled not to listen, the sound separation may be effective when the sound contrast of the area including the driver's seat 301 and the passenger seat 302 is 20 dB or more. That is, when the sound contrast of the driver's seat 301 and the passenger seat 302 is 20 dB or more, only the driver on the driver's seat 301 may listen to the sound from the speakers 400, and the passenger on the passenger seat 302 may not listen.

In the case of the prior art, only the sound signal from the speakers 400 provided in the vehicle 1 may be controlled so that the sound is output only to the determined area. In this case, the sound contrast of the determined area and areas other than the determined area is less than 20 dB. Therefore, in this case, the sound separation in each area in the vehicle 1 may not be completely implemented.

Therefore, in embodiments of the disclosure, the headrest speakers 600 may be provided in addition to the headrest provided in the seat of the vehicle 1, and the sound from the speakers 400 may be controlled to be output only to the determined area and also the sound may be output from the headrest speakers 400 provided in the determined area. Through this control, the sound may be output only to the determined area from the speakers 400 in the vehicle 1, and only the passenger located in the determined area may effectively listen to the sound output from the speakers 400.

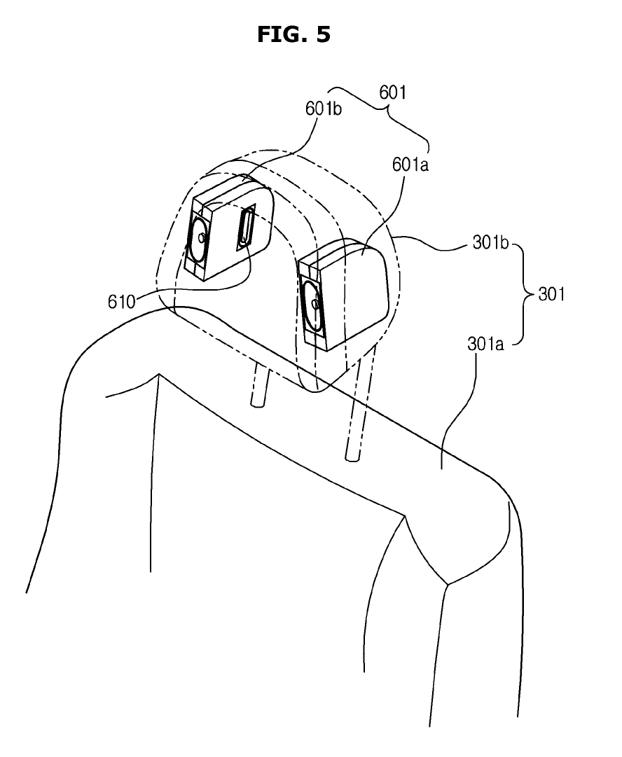

FIG. 5 is a perspective view illustrating a configuration of the headrest speaker according to embodiments of the present disclosure. As shown in FIG. 5, the headrest speakers 600 according to embodiments of the present disclosure may include a passive radiator 610.

Since the headrest speakers 600 installed in the headrest of the seat is small in size, a low-frequency sound signal may not be output effectively. Therefore, it is necessary to amplify the sound signal of the low frequency band so that the passenger of the vehicle 1 can hear the sound of the low frequency band through the headrest speakers 600. That is, the passive radiator 610 included in the headrest speakers 600 may amplify the sound signal having a frequency less than or equal to a predetermined value, and the passenger of the vehicle 1 may also listen to the amplified low frequency sound signal.

The controller 100 may generate a control signal for outputting a music playback signal, a video playback signal, a voice call signal, a navigation guidance signal, and various warning signals, and the speakers 400 may output the sound signal to the inside of the vehicle 1 based on the generated control signal.

The controller 100 may control a navigation device and an AVN device provided in the vehicle 1 and may generate the control signal so that sound is output from the speakers 400 in response to an image transmitted from the navigation device or the AVN device.

The sound that can be output from the speakers 400 may include music, a voice call sound, the navigation guidance sound, various warning signals, and the like. In addition, various sounds that can be output through the speakers 400 may be included.

According to the techniques prior to the disclosure, since the sound from the speakers 400 provided in the vehicle 1 is entirely output to the inside of the vehicle 1, the driver or the passenger of the vehicle 1 may simultaneously listen to the sound.

For example, the driver and the passenger of the vehicle 1 may have different desires to listen to the music output through the speakers 400. In other words, the driver and the passenger have to listen to the sound output collectively through the speakers 400 although the music to be listened to may be different.

In addition, in a case where a call is made through a Bluetooth connection inside the vehicle 1, a person other than the person who is making the call can listen to the contents of the conversation, so privacy of an individual may be infringed upon.

Therefore, according to the vehicle and the method for controlling the same according to the embodiments of the present disclosure, the sound from the speakers 400 provided in the vehicle 1 is output only to the predetermined specific area inside the vehicle 1, and not output to other areas, so that the driver or the passenger can selectively listen to the sound.

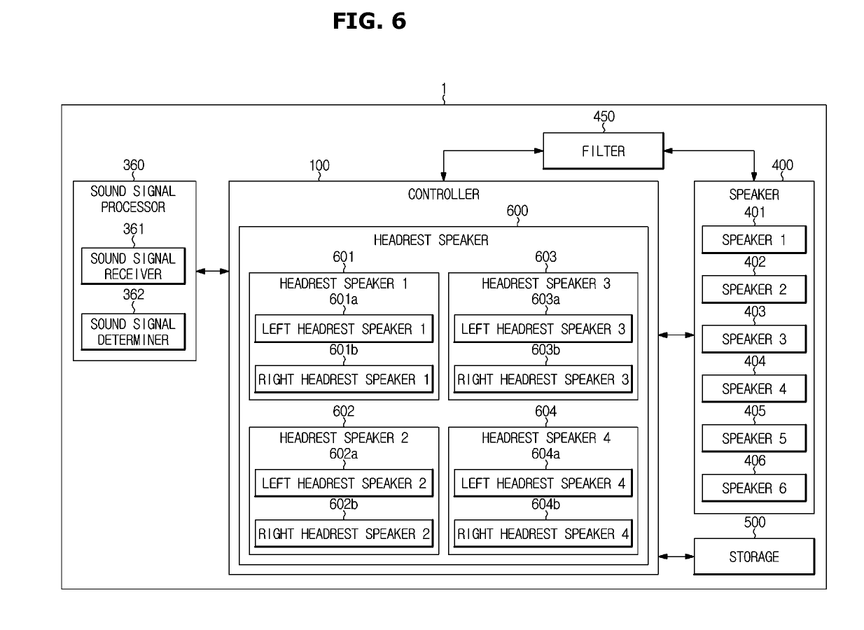

FIG. 6 is a block diagram illustrating the vehicle according to embodiments of the present disclosure. As shown in FIG. 6, the vehicle 1 according to the embodiments may include the controller 100 for collectively controlling the operation of the vehicle 1, a sound signal processor 360 for receiving a sound signal inputted from the outside of the vehicle 1, the speakers 400 for outputting the sound, a filter 450 for optimizing the sound signal from the speakers 400 or filtering the sound signal, a storage 500 for storing data related to the control of the vehicle 1, and at least one headrest speakers 600 provided in the headrest of the seat of the vehicle 1 for outputting the sound.

The controller 100 may divide an internal space of the vehicle 1 into a plurality of areas according to a predetermined reference (1000).

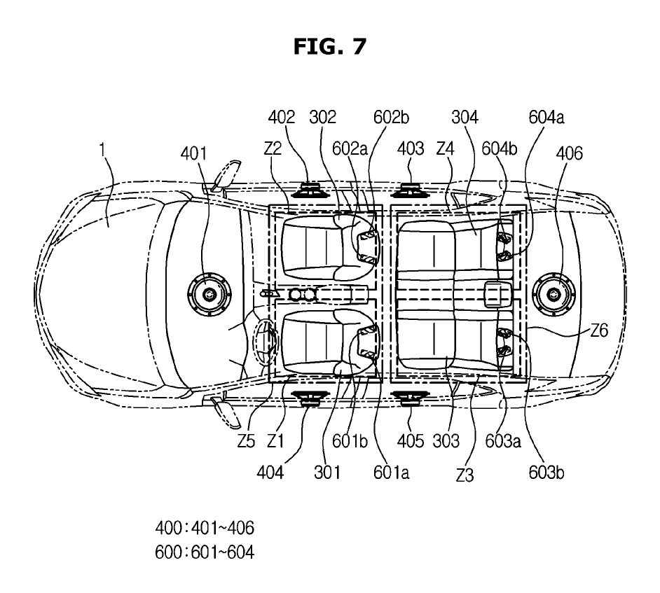

FIG. 7 is a conceptual diagram illustrating an internal space of the vehicle divided into one or more areas according to embodiments of the present disclosure. As shown in FIG. 7, the controller 100 may divide the internal space of the vehicle 1 according to various references. At this time, the reference that the controller 100 divides the internal space of the vehicle 1 may be predetermined and stored in the storage 500.

The controller 100 may divide the internal space of the vehicle 1 into a first area Z1 including the driver's seat 301, a second area Z2 including the passenger seat 302, a third area including the rear seat 303 of the driver's seat 301, and a fourth zone Z4 including the rear seat 304 of the passenger seat 302. At this time, the driver of the vehicle 1 may be located in the first zone Z1, and at least one passenger may be located at least one from among the second zone Z2, the third zone Z3 and the fourth zone Z4.

The controller 100 may also divide the internal space of the vehicle 1 into a fifth area Z5 including the driver's seat 301 and the passenger seat 302, and a sixth area including the rear seat 303 of the driver's seat 301 and the rear seat 304 of the passenger seat 302.

That is, the controller 100 may divide the internal space of the vehicle 1 into a plurality of areas according to the predetermined reference so as to control the sound from the speakers 400 to be output only to the specific area inside the vehicle 1.

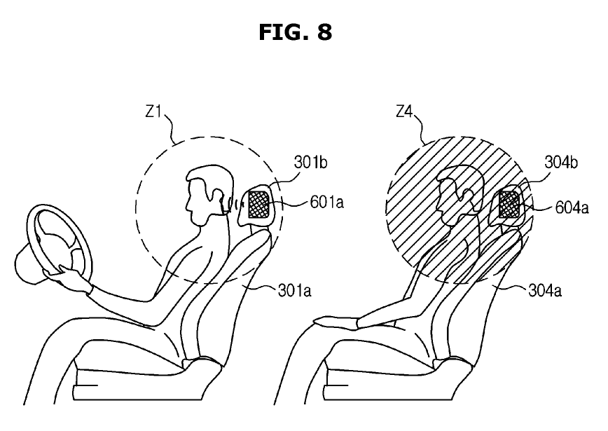

FIG. 8 is a side conceptual diagram determining an area where a sound of the speaker is output to the divided areas according to embodiments of the present disclosure. As shown in FIG. 8, the controller 100 may determine the area in which the sound from the speakers 400 among the divided areas inside the vehicle 1 is to be output (1100).

That is, the controller 100 may determine the area sound is to be output from the speakers 400 based on the predetermined reference by the driver or the passenger of the vehicle 1 or information input through an inputter.

For example, when the music signal playback from the vehicle 1 is listened to only the driver and the passenger other than the driver is set not to listen according to the setting of the driver, the controller 100 may determine the area where the driver is located in the divided area inside the vehicle 1 as the area where the sound is to be output from the speakers 400.

In addition, according to the setting of the driver, when the navigation guidance signal output through the vehicle display 307 or an external terminal such as a smart phone mounted in the vehicle 1 is listened to only by the driver and the passenger other than the driver is set not to listen, the controller 100 may determine the area where the driver is located in the divided area inside the vehicle 1 as the area where the sound is to be output from the speakers 400.

At this time, the sound signal processor 360 may receive the sound signal input from the outside of the vehicle 1. More specifically, the sound signal receiver 361 included in the sound signal processor 360 may receive the sound signal inputted through the external terminal such as the smart phone, which is stationed in the vehicle 1, and a sound signal determiner 362 may determine the type of the sound signal to be output through the speakers 400.

That is, the sound signal included in the music or the video output or playback through the vehicle display 307 for the vehicle 1 may be regarded as the sound signal included in the vehicle 1, and the sound signal included in the music or the video playback through the external terminal may be regarded as the sound signal received from the outside of the vehicle 1. Also, the voice call signal received through the smart phone may be regarded as the sound signal received from the outside of the vehicle 1.

The sound signal processor 360 may determine the sound signal from the vehicle 1 and the sound signal to be received and output from the outside of the vehicle 1, and the controller 100 may determine the area in which sound is to be output among the divided areas inside the vehicle 1 according to the type of the sound signal.

For example, when the type of the sound signal determined by the sound signal processor 360 is the music playback signal included in the vehicle 1, the controller 100 may determine the area through which the sound is output through the speakers 400 as the first area Z1 where the driver is located.

On the other hand, when the type of the sound signal determined by the sound signal processor 360 is the voice call signal received from the outside of the vehicle 1, the controller 100 may determine the area through which the sound is output through the speakers 400 as the fourth area Z4 where the passenger is located.

Referring again to FIG. 8, when the driver is located in the first area Z1 and the passenger is located in the fourth area Z4 among the divided areas inside the vehicle 1, the controller 100 may determine the area sound is to be output from the speakers 400 to the first area Z1.

That is, the controller 100 may determine the sound output area, so that the sound (for example, the music signal or the navigation guide signal) from the speakers 400 is output to the first area Z1 where the driver is located and not to output to the fourth area Z4 where the passenger is located.

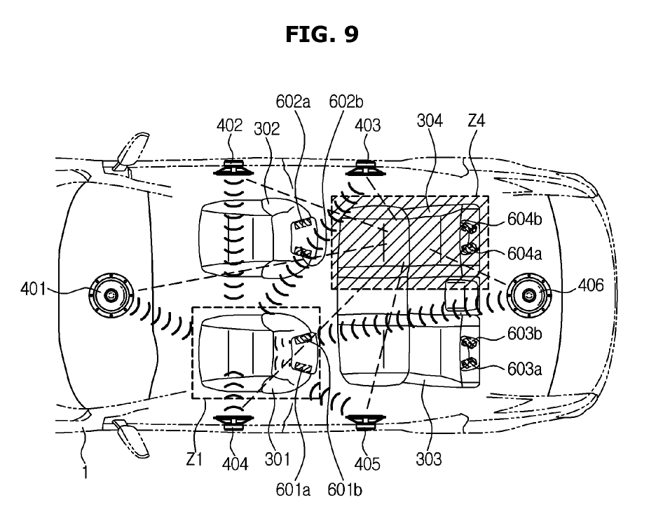

FIG. 9 is a conceptual diagram illustrating the sound of the speaker is output only to a determined area with respect to the divided areas according to embodiments of the present disclosure. As shown in FIG. 9, the controller 100 may generate a control signal for controlling the sound from the speakers 400 to be output to the determined area and not output to areas other than the determined area.

Specifically, the controller 100 may generate the control signal by which the sound signal of the speakers 400 being output to the determined area of the internal space of the vehicle causes the constructive interference (1210) and another sound signal being output to areas other than the determined area causes the destructive interference (1220).

That is, the controller 100 may control the sound signals from the speakers 400 provided in the vehicle 1 to be output only to the determined area, and not to output to all areas inside the vehicle 1 through the constructive interference and the destructive interference.

At this time, the controller 100 may generate the control signal for removing the sound signal output to areas other than the determined area from among the plurality of areas, which outputs the sound only to the determined area, so that only the driver or the passenger located in the area can listen to the sound signal.

The information on the constructive interference and the destructive interference by the combination of the sound signals from the speakers 400 provided in the vehicle 1 is preset and stored in the storage 500. Therefore, the controller 100 may generate the control signal that combines the sound signals from the speakers 400 based on the determined area.

The controller 100 may generate a constructive interference control signal and a destructive interference control signal on the sound signal from each of the speakers 400 based on a distance between at least one divided area inside the vehicle 1 and the speakers 400 provided in the vehicle 1.

That is, depending on the distance between the speakers 400 and the area inside the vehicle 1 determined by the controller 100, a phase difference may be caused between the sound signals from each of the speakers 400, depending on the phase difference, and the controller 100 may generate and modify the constructive interference control signal and the destructive interference control signal.

As described above in FIG. 8, when the controller 100 determines that the area to be output sound from the speakers 400 is the first area Z1, the controller 100 may generate the control signal for controlling the sound from the speakers 400 to be output to the first area Z1 and not output to areas other than the first area Z1.

The controller 100 may determine the area where the sound of the speakers 400 is output (1300).

In addition, the controller 100 may determine the headrest speakers 600 to which sound is to be output from the at least one headrest speakers 600 based on the type of the sound signal determined from the acoustic signal processor 360 (1400).

The speakers 400 may output the sound only to the first area Z1 due to the constructive interference caused by the control signal generated from the controller 100 (1520), and not output the sound to areas other than the first area Z1 due to the destructive interference caused by the control signal (1510).

That is, the constructive interference may be caused between the sound signals based on the phase difference of the sound signal from each of the speakers 400, and the sound signal may be output only to the first determined area Z1 by the constructive interference. Therefore, the driver of the vehicle 1 located in the first area Z1 may listen to the sound from the speakers 400.

In addition, the destructive interference may be caused between sound signals based on the phase difference of the sound signal from each of the speakers 400. The sound signal may not be output to the fourth area Z4 other than the predetermined first area Z1 by the destructive interference. Therefore, the driver of the vehicle 1 located in the first area Z1 may listen to the sound from the speakers 400, while the passenger located in the fourth area Z4 may not listen to the sound from the speakers 400.

The controller 100 may control the at least one headrest speakers 600 provided in the headrest of the determined area inside the vehicle 1 to output the sound (1530), and the headrest speakers 600 may output the sound to the determined area.

As described above, the controller 100 may determine the headrest speakers 600 to which the sound is to be output among the headrest speakers 600 based on the type of the sound signal determined from the sound signal processor 360.

When the controller 100 determines that the area sound is to be output from the speakers 400 is the first area Z1, the controller 100 may determine the left headrest speaker 1 601a and the right headrest speaker 1 601b installed in the seat of the first area Z1 among the headrest speakers 600 as the headrest speakers to which the sound is to be output.

The controller 100 may control the left headrest speaker 1 601a and the right headrest speaker 1 601b to output the sound. The driver located in the first zone Z1 may listen to the sound from the left headrest speaker 1 601a and the right headrest speaker 1 601b according to the control of the controller 100.

At this time, the passive radiator 610 included in the headrest speakers 600 may amplify the sound signal in the low frequency band.

The sound is output from the left headrest speaker 1 601a and the right headrest speaker 1 601b provided in the first zone Z1 inside the vehicle 1, so that the sound contrast for the first zone Z1 and areas other than the first zone Z1 may be 20 dB or more, and the driver may effectively listen to the sound from the speakers 400 in the first zone Z1. In addition, the passenger located in areas other than the first area Z1 may not listen to the sound from the speakers 400.

Referring again to FIG. 6, the filter 450 may filter the sound signals from each of the speakers 400.

As described above, the sound signals from each of the speakers 400 due to the constructive interference control signal and the destructive interference control signal generated by the controller 100 may cause the constructive interference or the destructive interference, and the generated control signal may be filtered in a predetermined form through the filter 450 so that the speakers 400 may generate the constructive interference or the destructive interference.

The filter 450 may be implemented by an algorithm of a transfer function type. The filter 450 may remove or pass a specific frequency band to the sound control signal generated by the controller 100 so that the sound signal of the speakers 400 is output only to the specific area inside the vehicle 1 predetermined by the controller 100.

That is, the sound output control signal generated by the controller 100 passes through the filter 450 and the specific frequency band is removed or passed, so that the sound signal may be output only to the determined area through the speakers 400.

In addition, the filter 450 may optimize the signal generated by the controller 100 so that the sound signal of the speakers 400 is efficiently transmitted to the determined area.

That is, the controller 100 may determine the control signal so that the sound signal can be outputted only to the predetermined area inside the vehicle 1 from the speakers 400. When the controller 100 generates the control signal so that the sound signal output to the determined area generates the constructive interference, the sound signal may be generated without the destructive interference in areas other than the determined area.

On the contrary, when the controller 100 generates the control signal so that the sound signal output to areas other than the determined area generates the destructive interference, the sound signal output to the determined area does not cause the constructive interference and the sound signal may be weakened.

Based on a predetermined optimization algorithm for the sound control signal generated by the controller 100, the filter 450 may optimize the control signal so as to generate the constructive interference without any offset for the sound signal output to the determined area inside the vehicle 1, and the filter 450 may optimize the control signal so as to generate the destructive interference without any enhancement for the sound signal output to areas other than the determined area.

Accordingly, the sound signal of the speakers 400 provided in the vehicle 1 may be output only to the determined area by the controller 100, and only the driver or the passenger located in the determined area may listen to the sound of the speakers 400.

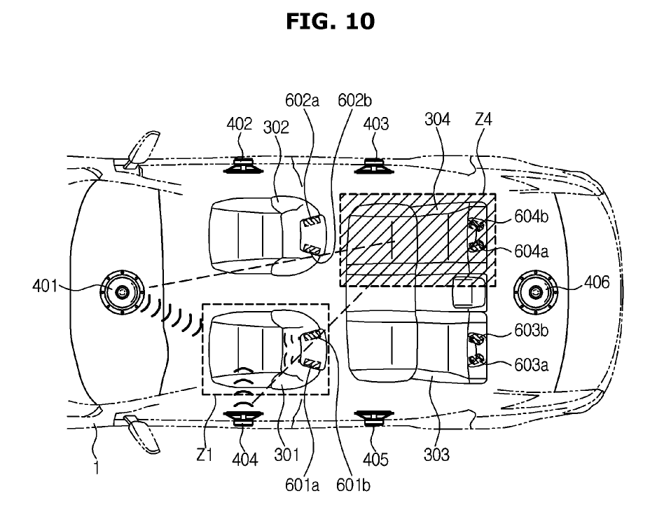

FIG. 10 is a conceptual diagram determining the speaker outputting the sound to the determined area according to embodiments of the present disclosure. As shown in FIG. 10, the controller 100 may determine the speaker outputting sound among the speakers 400, and generate the constructive interference control signal and the destructive interference control signal for the sound signal output from the determined speaker.

That is, as shown in FIG. 9, it is also possible to output the sound signal through the predetermined speaker without outputting the sound signal through all of the speaker 1 401 to the speaker 6 406 provided in the vehicle 1.

That is, as shown in FIG. 10, when the controller 100 determines the first area Z1 to output sound from the speaker, the controller 100 may determine the speaker 1 401 and the speaker 4 404 adjacent to the first area Z1 as the speakers.

The controller 100 may generate the constructive interference control signal for outputting sound only to the predetermined first area Z1, and generate the destructive interference control signal for preventing the sound from being output to areas other than the first area Z1, and transmit the destructive interference control signal to the speaker 1 401 and the speaker 4 404.

The speaker 1 401 and the speaker 4 404 may output sound to the first area Z1 due to the constructive interference caused by the control signal generated from the controller 100. Also, the speaker 1 401 and the speaker 4 404 may not output sound to areas other than the first area Z1 due to the destructive interference caused by the control signal of the controller 100.

When the controller 100 determines that the area sound is to be output from the speakers 400 is the first zone Z1, the controller 100 may control the left headrest speaker 1 601a and the right headrest speaker 1 601b to output the sound. Accordingly, the driver located in the first zone Z1 may listen to the sound from the left headrest speaker 1 601a and the right headrest speaker 1 601b according to the control of the controller 100.

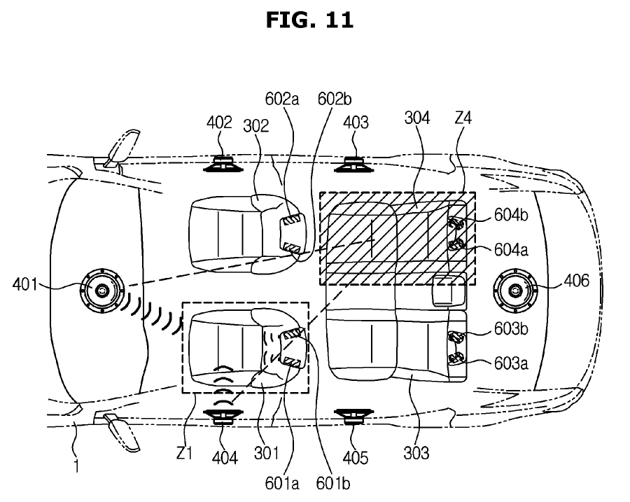

FIG. 11 is a side conceptual diagram determining an area where the sound of the speaker is output to the divided areas according to additional embodiments of the present disclosure. As shown in FIG. 11, the controller 100 may determine the area in which the sound of the speakers 400 from the divided areas inside the vehicle 1.

That is, the controller 100 may determine the area sound is to be output from the speakers 400 based on the predetermined reference by the driver or the passenger of the vehicle 1 or information input through the inputter.

The sound signal processor 360 may receive the sound signal input from the outside of the vehicle 1. More specifically, the sound signal receiver 361 included in the sound signal processor 360 may receive the sound signal input through the external terminal such as the smart phone, which is mounted in the vehicle 1, and the sound signal determiner 362 may determine the type of the sound signal to be output through the speakers 400.

The sound signal processor 360 may determine the sound signal output from the vehicle 1 and the sound signal to be received from the outside of the vehicle 1, and the controller 100 may determine the area to be output among the divided areas inside the vehicle 1 according to the type of the sound signal.

For example, when the type of the sound signal determined by the sound signal processor 360 is the voice call signal connected to Bluetooth through the smart phone mounted in the vehicle 1, the controller 100 may determine the area for outputting sound through the speakers 400 as the third area (Z3) where the passenger is located.

On the other hand, when the type of the sound signal determined by the sound signal processor 360 is the music playback signal, the controller 100 may determine the area for outputting the sound through the speakers 400 as the second area Z2 where the other passenger is located.

The controller 100 may determine the headrest speakers 600 to which the sound is to be output from the headrest speakers 600 based on the type of the sound signal determined by the sound signal processor 360.

Referring again to FIG. 11, when the passenger other than the driver is located in the second area Z2 among the divided areas inside the vehicle 1, and the other passenger is located in the third area Z3, the controller 100 may determine the area for outputting the sound as the third area Z3.

That is, the controller 100 may determine the sound output area such that the sound (voice call signal connected to Bluetooth through the smart phone) of the speakers 400 is output to the third area Z3 where the passenger is located and not output to the second area Z2 where the other passenger is located.

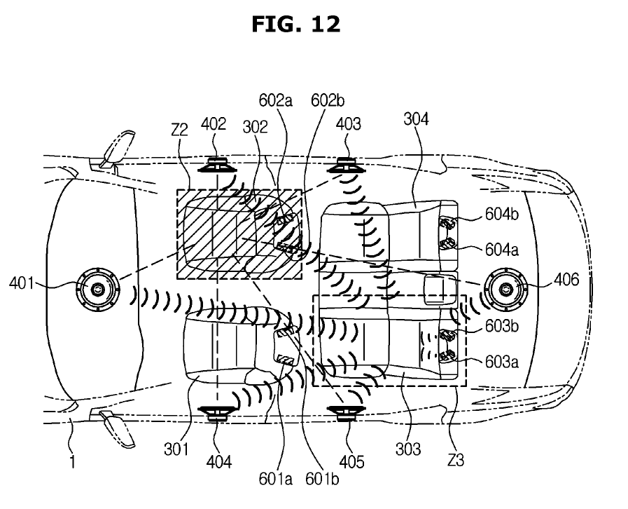

FIG. 12 is a conceptual diagram illustrating the sound of the speaker is output only to a determined area with respect to the divided areas according to additional embodiments of the present disclosure. As shown in FIG. 12, the controller 100 may generate the control signal for controlling the sound from the speakers 400 to be output to the determined area of the internal space of the vehicle and the sound not output to areas other than the determined area.

Specifically, the controller 100 may generate the control signal by which the sound signal of the speakers 400 being output to the determined area of the internal space of the vehicle causes the constructive interference and another sound signal being output to areas other than the determined area causes the destructive interference.

Referring to FIG. 12, as described above in FIG. 11, when the controller 100 determines that the area sound is to be output from the speakers 400 is the third area Z3, the controller 100 may generate the control signal for controlling the sound from the speakers 400 to be output to the third area Z3 and not output to areas other than the third area Z3.

The speakers 400 may output the sound only to the first area Z1 due to the constructive interference caused by the control signal generated from the controller 100 (1420). The speakers 400 may not output the sound to areas other than the first area Z1 due to the destructive interference caused by the control signal.

That is, the constructive interference may be caused between the sound signals based on the phase difference of the sound signal from each of the speakers 400, and the sound signal may be output only to the first determined area Z1 by the constructive interference. Therefore, the passenger located in the third area Z3 may listen to the sound of the speakers 400.

In addition, the destructive interference may be caused between sound signals based on the phase difference of the sound signal from each of the speakers 400. The sound signal may not be output to the second area Z2 other than the predetermined third area Z3 by the destructive interference. Therefore, the passenger located in the third area Z3 may listen to the sound from the speakers 400, while the passenger located in the second area Z2 may not listen to the sound from the speakers 400.

The controller 100 may control the speaker 600 provided in the headrest of the determined area inside the vehicle 1 to output the sound, and the headrest speakers 600 may output the sound to the determined area.

As described above, the controller 100 may determine the headrest speakers 600 to which the sound is to be output from the headrest speakers 600 based on the type of the sound signal determined by the sound signal processor 360.

In addition, when the controller 100 determines that the area sound is to be output from the speakers 400 is the third area Z3, the controller 100 may determine the left headrest speaker 3 603a and the right headrest speaker 3 603b provided in the seat of the third area Z3 among the headrest speakers 600 as the headrest speakers to which the sound is to be output.

The controller 100 may control the left headrest speaker 3 603a and the right headrest speaker 3 603b to output the sound, and the passenger located in the third zone Z3 may listen to the sound from the left headrest speaker 3 603a and the right headrest speaker 3 603b according to the control of the controller 100.

At this time, the passive radiator 610 included in the headrest speakers 600 may amplify the sound signal of the low frequency band.

The sound is output from the left headrest speaker 3 603a and the right headrest speaker 3 603b provided in the third zone Z3 inside the vehicle 1, so that the sound contrast for the third zone Z3 and areas other than the third zone Z3 may be 20 dB or more, and the passenger may effectively listen to the sound from the speakers 400 in the third zone Z3. In addition, the passenger located in areas other than the third area Z3 may not listen to the sound from the speakers 400.

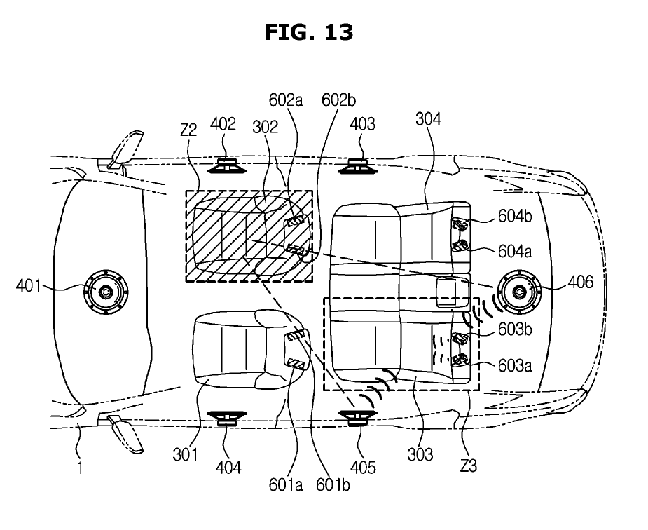

FIG. 13 is a conceptual diagram determining the speaker outputting the sound to the determined area according to additional embodiments of the present disclosure. As shown in FIG. 13, the controller 100 may determine the speaker outputting sound among the speakers 400, and generate the constructive interference control signal and the destructive interference control signal for the sound signal output from the determined speaker.

That is, as shown in FIG. 13 it is also possible to output the sound signal through the predetermined speaker without outputting the sound signal through all of the speaker 1 401 to the speaker 6 406 provided in the vehicle 1.

That is, as shown in FIG. 13, when the controller 100 determines the third area Z3 to output sound from the speaker, the controller 100 may determine the speaker 5 405 and the speaker 6 406 adjacent to the third area Z3 as the speakers.

The controller 100 may generate the constructive interference control signal for outputting sound only to the predetermined third area Z3, and generate the destructive interference control signal for preventing the sound from being output to areas other than the third area Z3, and transmit the destructive interference control signal to the speaker 5 405 and the speaker 6 406.

The speaker 5 405 and the speaker 6 406 may output the sound to the third area Z3 due to the constructive interference caused by the control signal generated from the controller 100. Also, the speaker 5 405 and the speaker 6 406 may not output the sound to areas other than the third area Z3 due to the destructive interference caused by the control signal of the controller 100.

When the controller 100 determines that the area sound is to be output from the speakers 400 is the third zone Z3, the controller 100 may control the left headrest speaker 3 603a and the right headrest speaker 3 603b to output the sound. Accordingly, the passenger located in the third zone Z3 may listen to the sound from the left headrest speaker 3 603a and the right headrest speaker 3 603b according to the control of the controller 100.

As is apparent from the above description, the vehicle and the method for controlling the same according to the embodiments of the present disclosure controls the sound from the speaker in the vehicle to be output only to a predetermined specific area inside the vehicle and not output to other areas so that only the person who desires to listen to the sound among the driver or the passenger can listen to the sound. Also, there is an effect that the passenger located in the determined area through the speaker provided in the headrest inside the vehicle can more effectively listen to the sound.

Meanwhile, the embodiments of the present disclosure may be implemented in the form of recording media for storing instructions to be carried out by a computer. The instructions may be stored in the form of program codes, and when executed by a processor, may generate program modules to perform an operation in the embodiments of the present disclosure. The recording media may correspond to computer-readable recording media.

The computer-readable recording medium includes any type of recording medium having data stored thereon that may be thereafter read by a computer. For example, it may be a ROM, a RAM, a magnetic tape, a magnetic disk, a flash memory, an optical data storage device, etc.

The exemplary embodiments of the present disclosure have thus far been described with reference to accompanying drawings. It will be obvious to people of ordinary skill in the art that the present disclosure may be practiced in other forms than the exemplary embodiments as described above without changing the technical idea or essential features of the present disclosure. The above exemplary embodiments are only by way of example, and should not be interpreted in a limited sense.

What is claimed is:

1. A vehicle comprising:
a plurality of speakers disposed in the vehicle;
a plurality of headrest speakers, each of which disposed in a headrest of a seat in the vehicle; and
a controller configured to divide an internal space of the vehicle into a plurality of areas according to a predetermined reference, to determine an area of the plurality of areas to be used as a destination of sound from a speaker of the plurality of speakers, to generate a control signal by which the sound from the speaker is output to the determined area and not output to any area of the plurality of areas other than the determined area, and to control a headrest speaker of the plurality of headrest speakers disposed in a headrest of a seat in the determined area so as to output the sound.

2. The vehicle according to claim 1, further comprising:
a sound signal processor configured to receive a sound signal corresponding to the sound from an external source.

3. The vehicle according to claim 2, wherein the sound signal processor is further configured to determine a type of the sound signal, the type of the sound signal corresponding to one of a music playback signal, a video playback signal, a voice call signal, a navigation guidance signal, and a warning signal.

4. The vehicle according to claim 3, wherein the controller is further configured to determine the headrest speaker to be used as a destination of the sound among the plurality of headrest speakers based on the determined type of the sound signal.

5. The vehicle according to claim 4, wherein each of the plurality of headrest speakers includes a passive radiator configured to amplify the sound signal when the sound signal has a frequency less than or equal to a predetermined value.

6. The vehicle according to claim 5, wherein the controller is further configured to control the passive radiator so as to amplify the frequency of the sound signal.

7. The vehicle according to claim 1, wherein each of the plurality of headrest speakers is installed at a predetermined angle in a particular headrest.

8. The vehicle according to claim 3, wherein the controller is further configured to determine the area to be used as the destination of the sound based on the determined type of the sound signal.

9. The vehicle according to claim 1, wherein the controller is further configured to generate the control signal such that the sound output to the determined area causes constructive interference and another sound output to any area of the plurality of areas other than the determined area causes destructive interference.

10. The vehicle according to claim 9, wherein the speaker is configured to output the sound to the determined area due to the constructive interference caused by the control signal, and to not output the sound to any area of the plurality of areas other than the determined area due to the destructive interference caused by the control signal.

11. The vehicle according to claim 1, wherein the controller is further configured to determine the determined area to be used as the destination of the sound based on a distance between one of the areas of the plurality of areas and the speaker.

12. The vehicle according to claim 9, wherein the controller is further configured to generate the control signal such that the constructive interference and the destructive interference caused by the sound is based on a distance between one of the areas of the plurality of areas and the speaker.

13. The vehicle according to claim 9, wherein the controller is further configured to determine the speaker for outputting the sound among the plurality of speakers, and to generate the control signal such that the constructive interference and the destructive interference is caused by the sound output from the determined speaker.

14. A method for controlling a vehicle comprising:
providing a plurality of speakers in the vehicle;
providing a plurality of headrest speakers, each of which disposed in a headrest of a seat in the vehicle;
dividing an internal space of the vehicle into a plurality of areas according to a predetermined reference;
determining an area of the plurality of areas to be used as a destination of sound from a speaker of the plurality of speakers;
generating a control signal by which the sound from the speaker is output to the determined area;
generating the control signal by which the sound is not output to any area of the plurality of areas other than the determined area; and
controlling a headrest speaker of the plurality of headrest speakers disposed in a headrest of a seat in the determined area so as to output the sound.

15. The method according to claim 14, further comprising:
receiving a sound signal corresponding to the sound from an external source.

16. The method according to claim 15, further comprising:
determining a type of the sound signal, the type of the sound signal corresponding to one of a music playback signal, a video playback signal, a voice call signal, a navigation guidance signal, and a warning signal.

17. The method according to claim 16, further comprising:
determining the headrest speaker to be used as a destination of the sound among the plurality of headrest speakers based on the determined type of the sound signal.

18. The vehicle according to claim 17, wherein the controlling of the headrest speaker so as to output the sound further comprises:
amplifying the sound signal when the sound signal has a frequency less than or equal to a predetermined value.

19. The vehicle according to claim 18, wherein the controlling of the headrest speaker so as to output the sound further comprises:
amplifying the frequency of the sound signal.

20. The method according to claim 16, wherein the determining of the area of the plurality of areas comprises:
determining the area to be used as the destination of the sound based on the determined type of the sound signal.

21. The method according to claim 14, wherein the generating of the control signal comprises:
generating the control signal such that the sound output to the determined area causes constructive interference and another sound output to any area of the plurality of areas other than the determined area causes destructive interference.

22. The method according to claim 21, further comprising:
outputting the sound to the determined area due to the constructive interference caused by the control signal; and
not outputting the sound to any area of the plurality of areas other than the determined area due to destructive interference caused by the control signal.

23. The method according to claim 14, wherein the determining of the area of the plurality of areas comprises:
determining the area to be used as the destination of the sound based on a distance between one of the areas of the plurality of areas and the speaker.

24. The method according to claim 21, wherein the generating of the control signal further comprises:
generating the control signal such that the constructive interference and the destructive interference caused by the sound is based on a distance between one of the areas of the plurality of areas and the speaker.

25. The method according to claim 21, further comprising:
determining the speaker for outputting the sound among the plurality of speakers; and
generating the control signal such that the constructive interference and the destructive interference is caused by the sound output from the determined speaker.
